(19) United States
(12) Patent Application Publication
(10) Pub. No.: US 2016/0277688 A1
(43) Pub. Date: Sep. 22, 2016

(54) LOW-LIGHT TRAIL CAMERA

(71) Applicant: THE SAMUEL ROBERTS NOBLE FOUNDATION, INC., Ardmore, OK (US)

(72) Inventors: Joshua Gaskamp, Marietta, OK (US); Michael C. Whittenburg, Broken Arrow, OK (US)

(21) Appl. No.: 14/661,812

(22) Filed: Mar. 18, 2015

(51) Int. Cl. H04N 5/33; A01M 23/00; H04N 5/232; H04N 7/18; H04N 1/00

(52) U.S. Cl. CPC H04N 5/332; H04N 7/183; H04N 1/00209; H04N 7/188; H04N 5/23206; A01M 23/00

(57) ABSTRACT

A trail camera that provides improved image capture performance in no-light or low-light conditions by using an image sensor that is sensitive to low-light conditions and has a sensitivity range encompassing visible and near infrared wavelengths. The image sensor may produce monochromatic image signals to be more sensitive and provide higher contrast imagery in both day and night conditions. The trail camera may use multiple communications channels to wirelessly communicate both locally and via a wide-area communications network. The trail camera may have a wide field-of-view, and further incorporate a motion sensor that has a like, aligned field-of-view. The trail camera may communicate image data, both still images and video images, to a remote user over the wide-area communication network. The trail camera further may transmit captured video images to a remote user without material time-shift, allowing the user to monitor a targeted area, day or night, in real-time. The trail camera may use a local communication protocol to communicate with, including command and control of or receive information/data from, devices, mechanisms and/or sensors external to the trail camera.

### BACKGROUND

Trail cameras have been used for decades to capture wildlife images using still imagery. Early trail cameras were tree-mounted cameras that used trip wires or rudimentary technology to take a single 35 mm picture of a target area. Today, trail cameras reflect the progression of camera technology and digital imagery. Modern trail cameras offer the ability to capture full-color, high resolution (8-10+ megapixels (Mps)) images, and in limited instances, short videos. For the most part, such imagery is stored on removable storage medium (e.g., memory cards), which are viewed hours or days later when a user visits the trail camera, removes the storage medium and views the captured images on a separate viewing device (e.g., a computer) or, alternatively, uses an integrated viewing screen of the camera.

In very limited instances, modern trail cameras have been adapted to transmit captured and stored imagery wirelessly. For such wireless transmissions, storage-transmission schemes are used to accommodate the movement of high-resolution imagery through a conventional wide-area communication network. These schemes include degrading captured imagery quality to produce smaller or compressed files sizes, transmitting only single images, and/or transmitting short videos that are recorded, stored and transmitted at appointed times (i.e., batch transmissions). These schemes, while pragmatic, provide sub-standard image quality and/or time-shifted (i.e., non-real-time) information to remotely located users. These trail cameras and their image handling schemes prevent their application for real-time monitoring of target sites and the ability to take immediate action based on transmitted image data from such target sites.

To manage power consumption, trail cameras commonly “sleep” between image capture events. It is common practice to stay in such a sleep mode until activity within a field-of-view (FOV) awakens the trail camera. Accordingly, trail cameras include motion detectors capable of detecting animals within such field-of-view (i.e., a motion field-of-view, MFOV). For modern trail cameras, the MFOV tends to be broader than an imaging FOV (IFOV) associated with the cameras' image sensor. The MFOV is dimensionally either (a) short (i.e., near range, 20-40 ft.) and wide (i.e., 45-70°) or (b) long (i.e., greater than 50 ft.) and skinny (i.e., <45°). Practically, the IFOV tends to focus on a target point or feature (e.g., an animal feeder) 20-40 ft. from the camera. It is due to this operational application that manufacturers focus, or narrow, the angle of the IFOV.

Lastly, it is notable that the image sensors used in today's trail cameras are well-suited for operation within the realm of visible light. For low-light/no-light environments, which is often the prevailing environment for the observation or capture of nocturnal animals or other similar targets, such image sensors do not perform optimally. Consequently, using conventional image sensors, today's trail cameras provide poor performance in low-light/no-light environments and diminished ranges and distances of operation relative to their theoretical maximums (as referenced above). Further yet, in those instances where image quality is reduced (e.g., compressed) through the use of an algorithm (or other mechanism) for wireless transmission, the overall quality of such images become further compromised or degraded.

In recent years, camera mechanisms have been combined with trapping systems to enable remote monitoring of such systems, and in limited instances, when such trail cameras are paired with separate (and external) actuation devices, a user has the ability to dial a number or take such other action to actuate a gate of a distantly located corral trap. Examples of such systems to assist in trapping feral hogs include, camera mechanisms as shown in U.S. patent application 2011/0167709, An animal trap requiring a periphery fence and U.S. patent application 2007/0248219, System and method for wirelessly actuating a movable structure, wherein this latter example may be directed to a remotely controlled gate/trap system. Combining the shortcomings discussed above (i.e., time-shifted imagery and poor image quality) with the intellect, numbers and mannerisms of potential targets being trapped (e.g., deer, bears, feral hogs), the operational outcomes are commonly non-optimal and incapable of responding to the challenges of real-time monitoring and trap actuation. Consequently, a need exists.

Overpopulation of wild animals, such as feral hogs (or wild pigs), can be problematic in a number of ways. Feral hogs may damage trees, vegetation, agricultural interests, and other property—including in recent years, cemeteries and golf courses. According to popular press articles and experts in this field, the extent of property damage associated with feral hogs is estimated to be as high as $1.5 billion annually in the United States alone with approximately $800 million attributed to agricultural losses. It is widely accepted that feral hog damage is expanding, wherein destructive feral hog activity has been regularly reported in more than forty states. In addition to direct damage to real property, feral hogs may prey on domestic animals such as pets and livestock, and may injure other animal populations by feeding on them, destroying their habitat and spreading disease. Feral hogs are not limited to the United States.

The size and number of feral hogs in the United Sates contribute to their ability to bring about such destruction. Mature feral hogs may be as tall as 36 inches and weigh from 100 to 400 lbs. Feral hog populations are difficult to ascertain but are staggering in size. In Texas alone, feral hog populations are estimated to range from 1.5-2.4 million. The animals' population rates are attributed to the limited number of natural predators and high reproductive potential. Sows can produce up to ten piglets per litter and may produce two litters per year. Further, piglets reach sexual maturity at six months of age, underscoring the animals' ability to quickly reach a state of overpopulation.

Feral hogs travel in groups, or sounders, including 8-20 hogs per sounder. Feral hogs are relatively intelligent animals that have keen senses of hearing and smell and quickly become suspicious of traps and trap systems. Further, hogs that escape a trapping event become “educated” about failed attempts, trap mechanisms and processes. Through research, it is shown that such education is shared amongst hogs within a sounder and across sounders, which can heighten animal-shyness and render traps less effective (i.e., requiring extended animal re-training, which reduces the efficiency of such trapping operations).

Because of their destructive habits, disease potential and exploding numbers, it is desirable to artificially control their populations by hunting and trapping them. To control or reduce feral hog populations, it is required that approximately 70+% of hogs be captured/harvested annually. Hunting provides limited population control. Further, animal-actuated traps are not effective, which are only capable of capturing one or two animals per trapping event. Accordingly, to effectively control feral hog populations within a geography, it is critical to regularly and consistently capture all hogs within each sounder.

To achieve this goal, a trap system is required that can (a) physically accommodate a feral hog sounder(s); (b) allow a remote user to clearly monitor and observe, in real-time, the on-going and erratic animal movements into and out of a trap area in both day and night conditions; and (c) control actuation of a trapping mechanism to effect animal capture. More specifically, a need exists for an improved, advanced trail camera that can function in the traditional role of a trail camera to offer enhanced functionality in low-light/no-light environments and/or serve as a central control component of the above-described trap system.

### SUMMARY

To provide users of trail cameras with the ability to better view animals within a natural environment, particularly, in low-light (and even no-light) conditions, the principles of the present invention provide for a trail camera that provides better light sensing in low-light conditions than existing trail cameras. In providing the better low-light sensing, the trail camera provides an image sensor that has an operational range that includes visible light (day operations) and near infrared (NIR) (low-light/night operations), which aligns with a light source integrated into the trail camera. The trail camera may use a monochromatic image sensor that is responsive to ambient light conditions and provides a high-contrast, high performance image output. Further yet, such monochromatic image sensor provides high-quality imagery at a lower resolution (approximately 1 Mps v. 8+ Mps), which further enables increased storage of such imagery and/or the transmission of real-time video of a monitored target area via a local or wide-area communication network to a remote user. An infrared light source (operatively aligned with a wavelength sensitivity of the image sensor), such as an array of light emitting diodes (LEDs), may be used to selectively illuminate a monitored target area in low-light or no-light conditions.

One embodiment of a trail camera to transmit image data to a communications network to enable a remote user to monitor a scene in real-time may include a lens configured to capture the scene, an infrared (IR) illumination device configured to illuminate the scene at an IR wavelength, and an image sensor being configured to sense the scene being captured by the lens and to produce image signals representing the scene. The image sensor further may have a wavelength sensitivity at the IR wavelength. The trail camera may further include a processing unit in communication with the image sensor. The processing unit may be configured to receive and process the produced image signals. The trail camera may further include an antenna, configured to communicate with the communications network, and an input/output (I/O) unit, configured to communicate with both the processing unit and the antenna. The I/O unit further is configured to communicate image signals from the processing unit to the communications network proximate to production of such image signals. A housing may be adapted to house the lens, IR illumination device, image sensor, processing unit, and I/O unit.

Another embodiment of a trail camera configured to communicate to a communication network to enable a user to monitor a horizontal, first field-of-view encompassing a target area and receive data from an external device located proximate to such target area may include a housing, a lens configured to capture the first field-of-view, an infrared (IR) illumination device configured to selectively illuminate the first field-of-view at an IR wavelength, and an image sensor having a wavelength sensitivity at least at the IR wavelength. The image sensor further may sense the first field-of-view and produce image signals representing the sensed first field-of-view. The trail camera further may include a processor, which receives and processes image signals from the image sensor, and an antenna configured to communicate with the communication network. To facilitate communications, the trail camera further may include an input/output (I/O) unit and a transceiver. The I/O unit may communicate with the processor and the antenna to communicate image signals from the processor to the communications network proximate to production of such image signals. The transceiver may communicate with the I/O unit as well as the external device and is configured to receive data from the external device. The housing is adapted to house the lens, IR illumination device, image sensor, processor, and I/O unit.

One embodiment of an animal trapping system may be viewable and controllable by a remote user using an electronic device. The system may include a trap enclosure configured to deploy to confine animals within a trap area and a controller configured to deploy the trap enclosure in response to a user-issued command. The system may further include a head unit that includes both a camera unit and multiple communications modules. The head unit is configured to produce video signals representative of at least the trap area, communicate with the electronic device via a wide-area communications network, and communicate with said controller via a local wireless network. The head unit further is configured to transmit produced video signals to the electronic device for user-viewing proximate to production of the video signals, receive a user-issued command from the electronic device, and transmit the received user-issued command to the controller to deploy the trap enclosure to confine animals within the viewed trap area as viewed via the electronic device.

### BRIEF DESCRIPTION OF THE DRAWINGS

Illustrative embodiments of the present invention are described in detail below with reference to the attached drawing figures, which are incorporated by reference herein and wherein:

FIGS. 1A-1D are illustrations of a trail camera unit used for capturing images in low-light conditions;

FIGS. 2A and 2B are top view and side view illustrations, respectively, of horizontal and vertical fields-of-view of an image sensor lens of the trail camera unit of FIG. 1;

FIGS. 3A and 3B (collectively FIG. 3) are two illustrative captured images for comparative purposes, where the images include a first image captured by an embodiment of a trail camera and a second image from a conventional trail camera;

FIG. 4 is an illustration of electrical components of the trail camera unit of FIG. 1;

FIG. 5 is a block diagram of illustrative software modules configured to be executed by the processing unit of the trail camera unit of FIG. 1;

FIG. 6 is a schematic diagram of one embodiment of a system for remotely capturing images and wirelessly transmitting such images to one or more remote user devices;

FIG. 7 is a schematic diagram of one embodiment of a system for remotely viewing a trap area and effecting the actuation of an animal trap to contain one or more trapped animals;

FIG. 8 illustrates an operational example of the system of FIG. 7; and

FIG. 9 illustrates an alternative operational example of the trail camera.

### DETAILED DESCRIPTION OF THE DRAWINGS

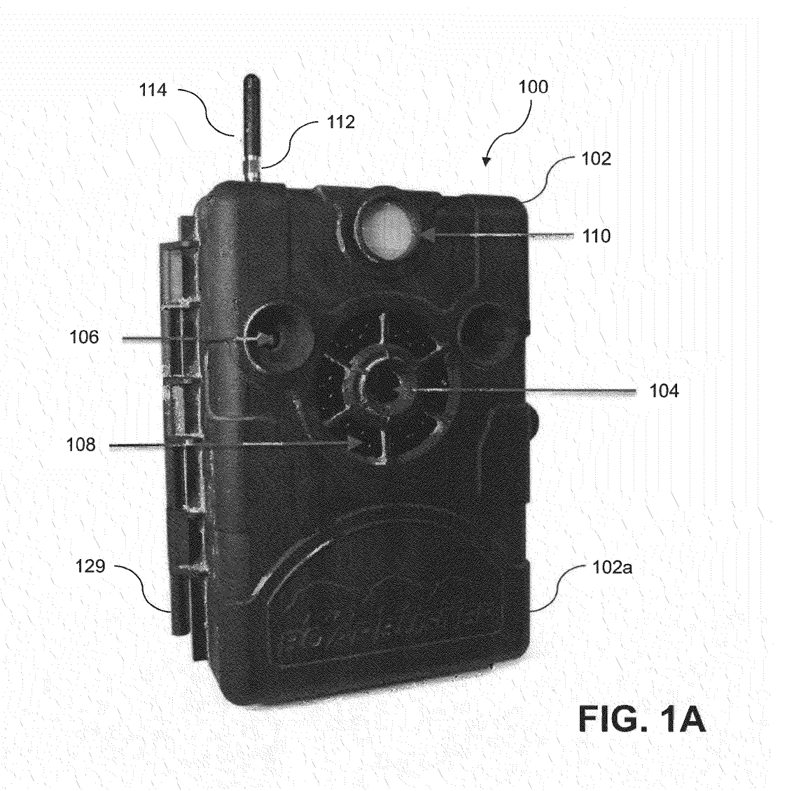

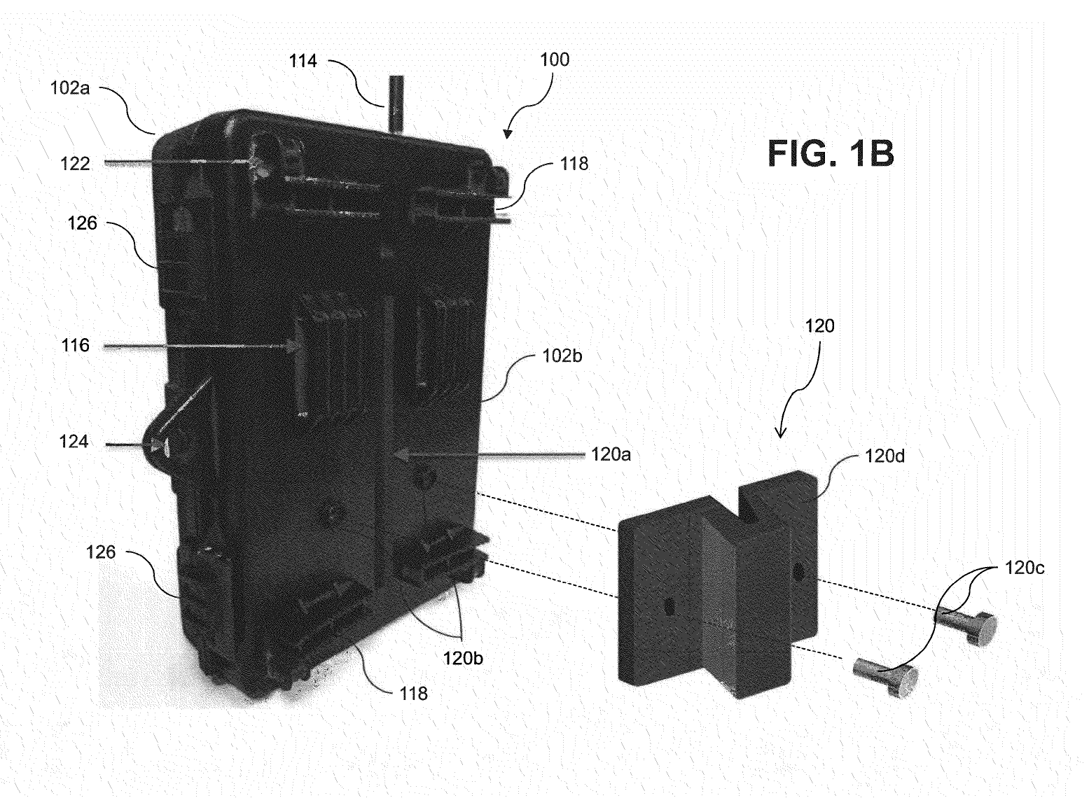

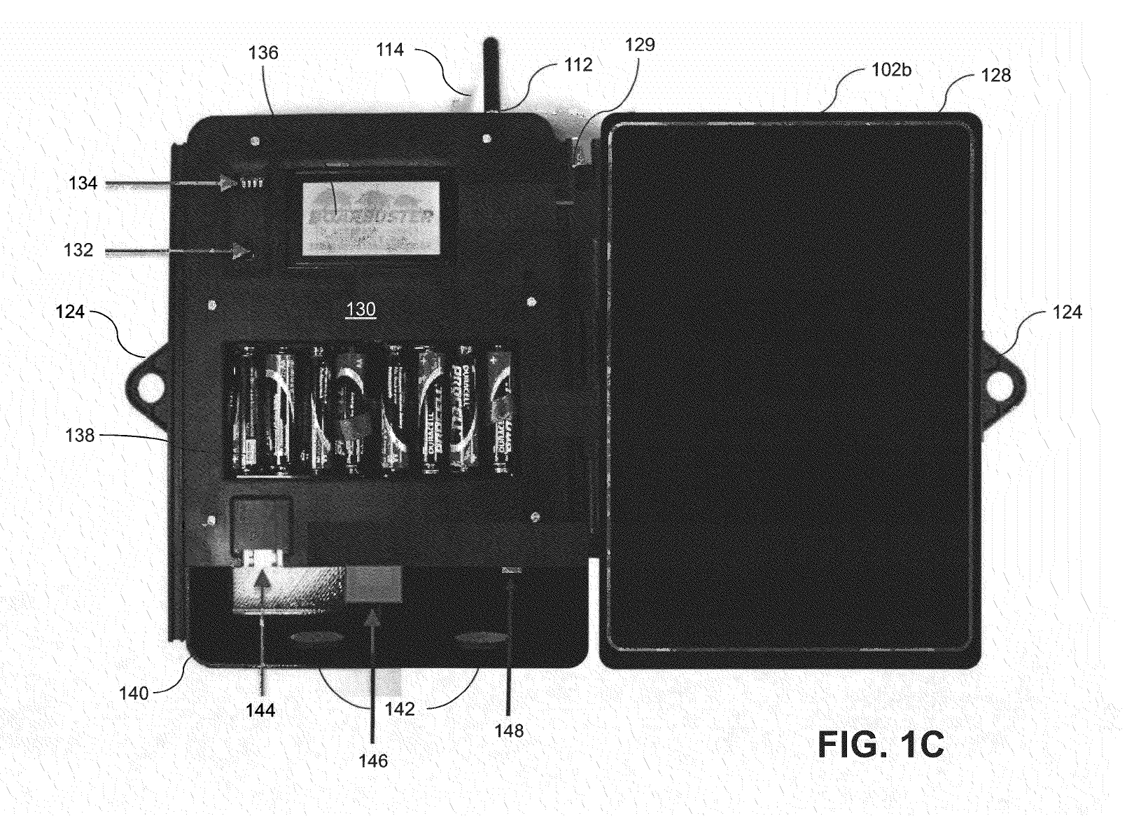

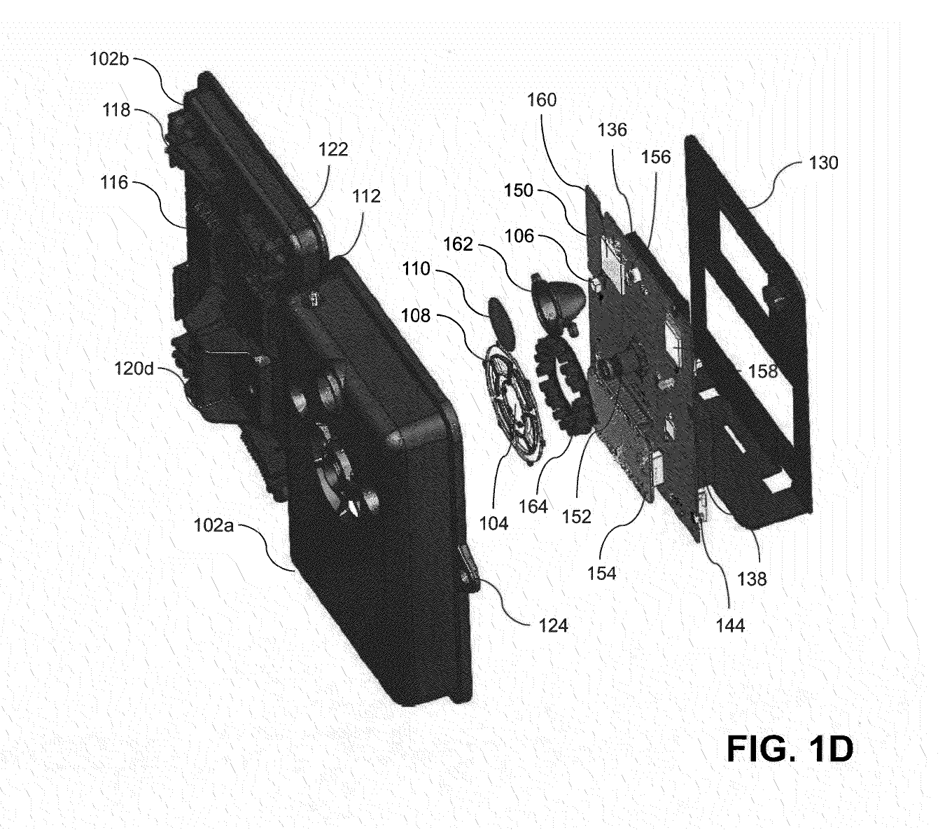

FIGS. 1A-1D are illustrations of a low-light trail camera unit 100 according to one embodiment. As shown in at least FIGS. 1A and 1B, the camera unit 100 includes a housing 102, formed of a front housing 102a and a rear housing 102b. The front housing 102a serves to encase the various, internal components of the camera unit 100 (described in detail below); the rear housing 102b, which sealingly engages the front housing 102a when closed, includes structural features for enabling attachment of the camera unit 100 to external, natural and man-made supporting features (described in detail below). In one embodiment, the housing 102 is adapted for outdoor use, where outdoor use may include being water resistant or waterproof to prevent rain, moisture and environmental contaminants (e.g., dust) from entering the housing 102. The housing may also be configured to limit temperature highs and lows within the housing by being formed of certain materials, incorporating heat sinks, using a fan when a temperature reaches a certain level, integrating insulation, or otherwise. Housing 102 can be formed from plastic, thermoplastic, metal, a composite material or a combination of these materials.

As specifically shown in FIG. 1A, the front housing 102a may have openings defined therein that allows internalized components access to an external operating environment by passing through the front housing 102a, or the front housing 102a may be constructed to selectively integrate such components into the front housing 102a. While any number of components related to or enabling the functionality of the camera unit 100 may maintain such configuration(s) relative to the front housing 102a, at least for the illustrated embodiment the following components are shown, which will be discussed in greater detail below: an image sensor cover 104, an ambient light sensor 106, an illumination source lens 108, a motion detector lens 110 and, for a communications-enabled camera unit 100, an antenna connector 112 with an external antenna 114.

With regard to FIG. 1B, an illustration of the rear housing 102b of the camera unit 100 is shown. For the illustrated embodiment, the rear housing 102b serves as a platform for and may be configured in multiple ways to facilitate a secured support or removable attachment of the camera unit 100 to natural and/or man-made supporting features. While a number of independent structural elements are illustrated, it is understood that all such elements may be provided (as shown) or individual elements may be selected and provided without regard to other such elements.

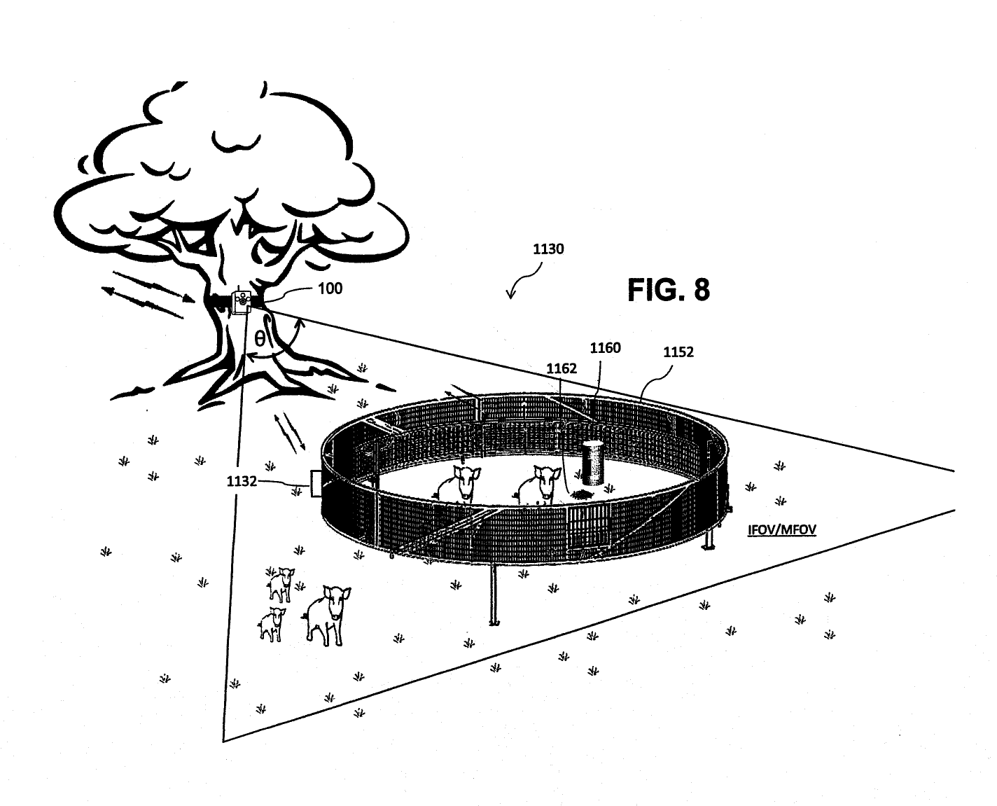

The rear housing 102b may provide mounting strap pass-thrus 116 that are configured to accommodate a mounting strap (FIG. 8), which is passed through the mounting strap pass-thrus 116 and around a supporting feature, for example, a tree (FIG. 8), to tether the camera unit 100 to such supporting feature. As a complement to such a tether, the rear housing 102b may further include multiple, in this case four, “tree grabbers” 118 that function to press against the supporting feature to fix the position of the camera unit 100 position and better hold it in place when tethered.

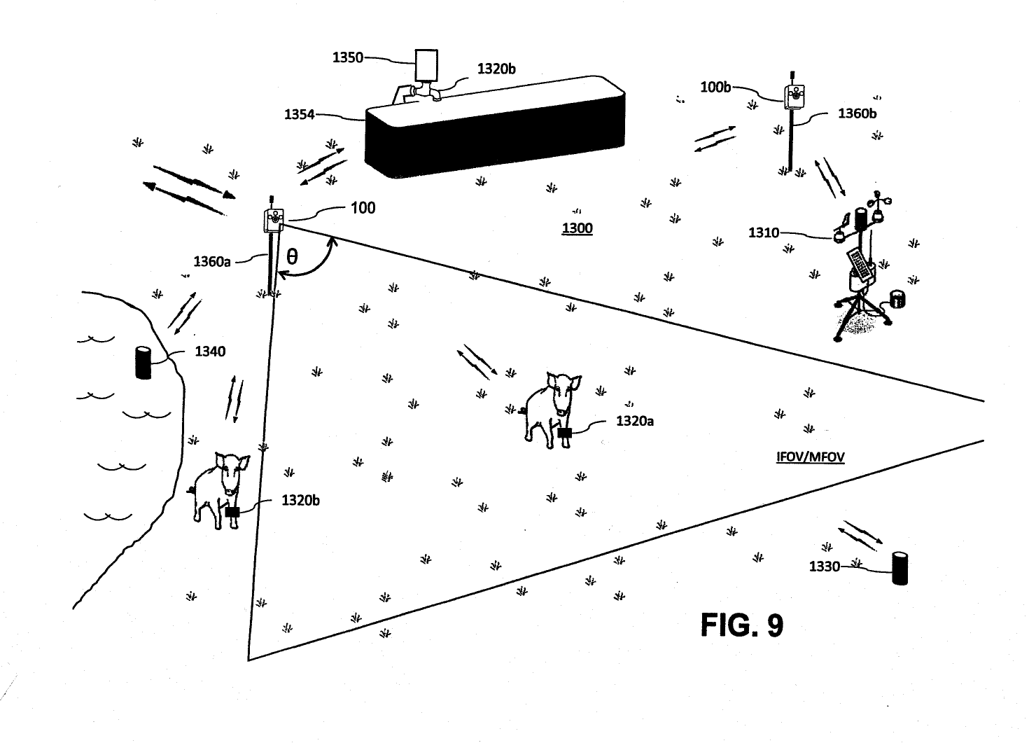

The rear housing 102b may incorporate a T-post mounting system 120 inclusive of a recessed element 120a to accommodate a studded T-post (FIG. 9) and recesses 120b to receive releasable fasteners 120c to secure a post clamp 120d. Operatively, a studded T-post is positioned so that the studded surface of the T-post is received within the recessed element 120a. The post clamp 120d is then positioned so as to “sandwich” the T-post between the rear housing 102b and the post clamp 120d. In an embodiment, the recesses 120b are threaded and the post clamp 120d accommodates complementary threaded fasteners 120c that are inserted and secured within the recesses 120b. The T-post mounting system 120 provides a user a mounting option when trees or other natural features are not readily available or when other mounting options are desirable.

To better ensure the physical security of the camera unit 100 once it is placed at a monitoring site, the housing 102 may further include a security cable pass-thru 122 to accommodate a steel cable (or other cable-like element) with a locking mechanism (not shown). Operatively, once the camera unit 100 is positioned and secured to a supporting feature, a cable is passed through the security cable pass-thru 122 to (a) encompass the supporting feature or (b) secure the camera unit 100 to a proximate, immobile object (not shown). Additionally, the housing 102 may further include an integrated lock point 124, which is formed when the front housing 102a and the rear housing 102b are brought together, to create a common pass-thru. Through such pass-thru, a standard lock (e.g., combination, keyed) or other securing element (e.g., carabiner, clip) (not shown) may be inserted and secured to ensure that the housing 102 is not readily opened and better ensure that an unintended person does not access the interior of the camera unit 100.

In a closed position, as shown, the front housing 102a and the rear housing 102b are brought together, pivoting around hinge 129 (FIGS. 1A and 1C). Once brought together, the front housing 102a and the rear housing 102b are secured relative to one another using latches 126. The latches 126 apply a constant, even pressure against the front housing 102a and the rear housing 102b, which causes seal 128 (FIG. 1C), formed into the rear housing 102b, to compress against an edge of the front housing 102a to create a weatherproof or waterproof seal against environmental intrusion. The illustrated configuration is but one embodiment, and to those skilled in the art, the latches 126 could be sliding in nature, could be threaded fasteners, or could be other structural configurations. Moreover, to those skilled in the art, it is known that the seal 128 may be external to the housing 102 or a combination of internal and external structures or elements.

With regard to FIG. 1C, an interior control panel 130 of the camera unit 100 is shown, such control panel 130 is accessible when the latches 126 are disengaged and the rear housing 102b is opened. In addition to covering electronics and components (FIG. 1D) internal to the front housing 102a, the control panel 130 offers users a power switch 132 to enable a user to activate and deactivate the camera unit 100. The control panel 130 may further offer dip switches 134 (or other like element) to uniquely identify each camera unit 100 for purposes of, in one embodiment, communicating and controlling external devices, which will be discussed below regarding alternative embodiments. As an alternative to switches 134, the camera unit 100 may include a digital “signature,” established by software or firmware, which is preferably easily and readily programmable by a user based on environment, needs, and operational requirements.

The control panel 130 may include a graphical display 136, such as a liquid crystal display (LCD), to enable a user to set up various functions of the camera unit 100, receive status information regarding the camera unit 100 (e.g., battery strength, wireless signal strength (if applicable), self-diagnostics), and in an alternative embodiment, view images and/or video captured by the camera unit 100. As further shown, a battery compartment 138 is provided to receive internal batteries to provide power to the camera unit 100. In this case, the illustrated power source includes eight AA batteries, but alternative battery numbers or sizes may be utilized with this or another configuration of the camera unit 100.

While not illustrated in FIG. 1C, an integrated keypad or other data entry elements may be provided on the control panel 128 to allow a user to directly enter or submit data, instructions, or other commands to the camera unit 100. Alternatively, such data, instructions or command submissions may be achieved through a connectable or wireless keypad (not shown), or preferably, such data, instructions or other commands may be entered or submitted to the camera unit 100 wirelessly (e.g., cellular connection, Bluetooth®) using an external device (e.g., phone, computer, pager).

As shown in this embodiment, the control panel 130 does not fully span the height of the interior of the front housing 102a. As a consequence, an internal cavity 140 is created that can provide access to a variety of internalized connection points and ports, as described further below. By including the connection points and ports interior to the camera unit 100, the connection points and ports are further protected and do not require their own (susceptible) individual weatherproofing/waterproofing. Consequently, there exists less opportunity for system failure due to weather or environmental interference. Access to the exterior of the housing 102, for example, for cabling is provided through weatherproof or waterproof pass-thrus 142.

For a communications-enabled embodiment, an Ethernet (or other similar connector, for example, USB) port 144 may be available to enable the camera unit 100 to communicate via an external communications network, either wired or wireless. Additionally, the port 144 may be used to connect accessories, for example, an external antenna (not shown) to the camera unit 100 to enhance connectivity (e.g., range and/or quality) of the camera unit 100 in remote or rural locations. Additionally, the port 144 could accept control and command devices, as described above, such as an external keyboard or video/image replay device. The camera unit 100 may accommodate a removable memory card 146, such as a secure digital (SD) card, so that captured data, including image data, may be collected and stored. The camera unit 100 may further include an auxiliary power input port 148 to enable connection of the camera unit 100 to an external power source (not shown), such as a battery, solar panel, wind generator, or other similar external power source. While in the illustrated configuration, an auxiliary power source (via input port 148) compliments the internal power source (provided through batteries within the battery compartment 138), the camera unit 100 may not include any internal power source and may rely solely on an external power source.

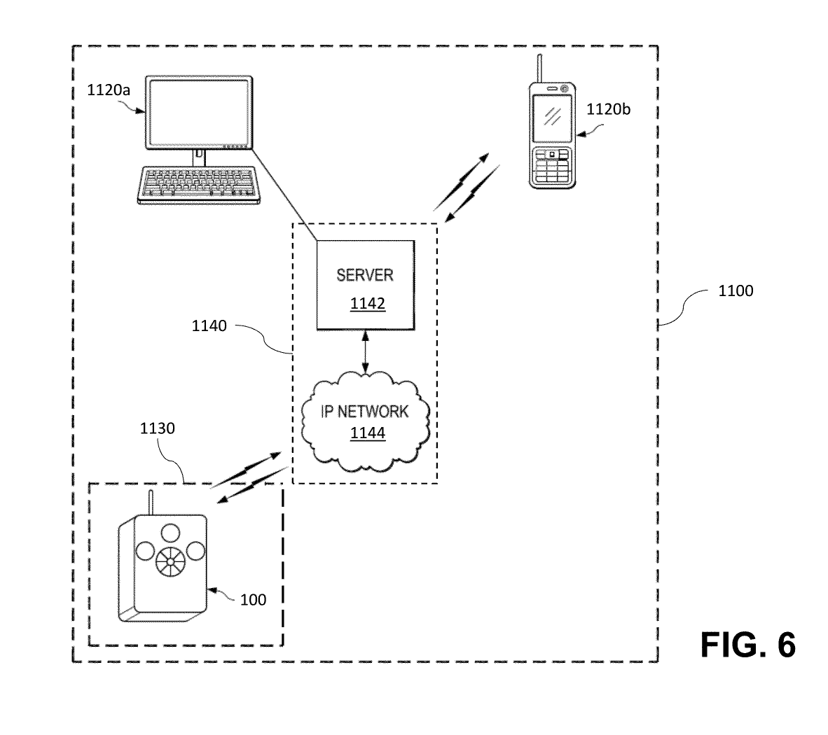

As illustrated in FIGS. 1A-1C, for those embodiments of the camera unit 100 that are communications-enabled, the camera unit 100 may include an antenna connector 112 connectable to an antenna 114. Antenna 114 facilitates wireless communication between the camera unit's 100 electrical and physical components and a communication network (FIGS. 5 and 6). As shown, the antenna 114 is a cellular antenna; however, this antenna may be a radio antenna or other antenna to enable long-distance, wide-area wireless communications. Moreover, as understood in the art, the antenna 114 may also be integrated into the housing 102 or incorporated into the components (e.g., printed wiring boards) located within the front housing 102a.

With regard to FIG. 1D, an exploded view of one embodiment of the electrical and physical components of the camera unit 100, located between the front housing 102a and the control panel 130, is shown. In the illustrated embodiment, central to the camera unit 100 is a main printed circuit board (PCB) 150 that supports and includes circuitry, such as one or more computer processors 158 for processing commands, handling and managing data and executing software; an image sensor/lens 152 for generating image-related data within an image field-of-view (IFOV); a video engine 154 to process captured, or detected, image data; a passive infrared (PR) sensor 156 for detecting motion forward of the camera unit 100 within an motion field-of-view (MFOV); and/or memory for storing software (not shown). As should be understood by those skilled in the art, combination (of elements), placement, and/or arrangement of such components may be modified and remain consistent with the disclosure herein. For a communications-enabled camera unit 100, the PCB 150 further includes one or more communications modules 160, including for example, a cellular engine, to enable the camera unit 100 to communicate over a local, wide-area, and/or multiple communications channels. The communications module(s) 160 may be coupled to, physically and/or electrically, the antenna connector 112. For a cellular-enabled camera unit 100, the relevant communications module 160 may operatively receive or couple to a subscriber identification module (SIM) card (not shown) configured to enable and disable communications with a communications network based on a subscription service. For example, select components of the camera unit 100 (e.g., main PCB 150) may include multiple PCBs and/or additional elements and operatively and functionally interconnected using, for example, connectors, wiring harnesses or other connective infrastructure.

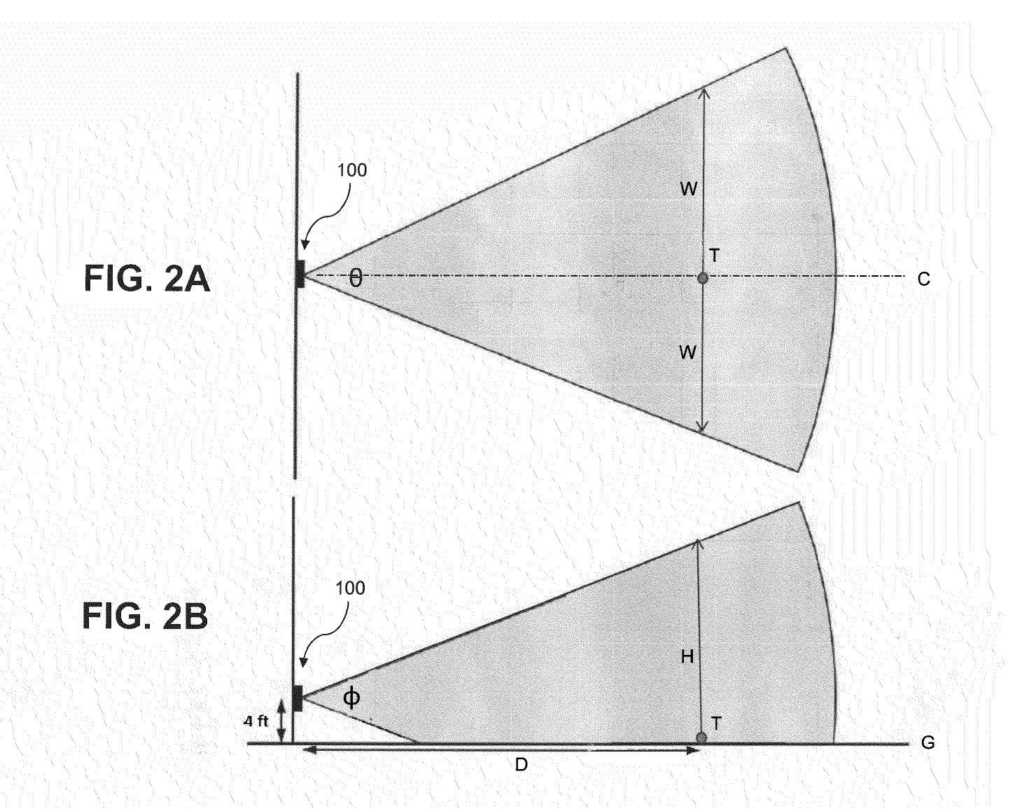

In further reference to FIG. 1D, a passive infrared (PIR) cone 162 may be used for collecting infrared light for the PIR sensor 156. A PIR lens 110 may be disposed in front of the PIR cone 162, which encompasses and operatively interacts with the IR sensor 156. The PIR lens 110 and PIR cone 162 collectively gather and focus reflected light onto the PIR sensor 156, which “views” a prescribed MFOV. In reference to FIG. 2A, the operational range of the PIR sensor 156 should extend beyond distance (D) on the centerline (C) (as but one example, for D equal to 35 ft., the motion sensing capabilities of the camera unit 100 may be configured to extend to at least 40-45 ft.). In one configuration, for a mounted height of the camera unit 100 (e.g., 4 ft.), the PIR cone 162 may be angled to direct the focus of the PIR sensor 156. It is recognized that the motion sensing capabilities of the PIR sensor 156 may be adversely influenced by environmental conditions (e.g., weather).

As shown, the image sensor/lens 152 incorporates a lens, lens holder and image sensor; provided, however, these elements may be separate and distinct rather than as shown. The image sensor/lens 152 preferably includes a monochromatic, light-sensitive sensor capable of dynamic operation in day/night operations. In an embodiment, the image sensor/lens 152 has low-light (e.g., 0 lux) sensing capabilities and is calibrated for enhanced near infrared (NIR) detection, i.e., night vision capability with NIR (e.g., 850 nm wavelength) to detect non-visible light. For NIR applications, the image sensor/lens 152 provides increased sensitivity to reduce the need for applied light (e.g., LED lighting requirements). An image sensor/lens 152 having the above-described characteristics facilitates a lower image resolution, for example, approximately one megapixel. These imaging characteristics provide additional capabilities and user flexibility for a communication-enabled embodiment of the camera unit 100, including transmission capabilities that allow real-time streaming video of captured video or transmission of still images via a wide-area communication network (e.g., cellular network).

In an embodiment, the image sensor of the image sensor/lens 152 may have a pixel size of 3.75 μm×3.75 μm. The frame rates of the image sensor of the image sensor/lens 152 may include a range of operation, including 1.2 megapixel or VGA (full IFOV) at approximately 45 fps or 720 pHD or VGA (reduced IFOV) at approximately 60 fps. For representative performance, the image sensor of the image sensor/lens 152 may have a responsivity of 5.5V/lux-sec at 550 nm, a dynamic range at or about 83.5 db and a quantum efficiency of 26.8%. The integrated lens of the image sensor/lens 152 may have a focal length of 4.5 mm, relative aperture of F2.3, and a wavelength bandwidth that extends from visible through NIR. This integrated lens, at least for this embodiment, is adapted and tuned to a 1.2 megapixel sensor (or the resolution of the underlying sensor of the image sensor/lens 152).

In one embodiment, the image sensor/lens 152 may be an Aptina image sensor (model number AR0130CS) with an optical format of one-third of an inch. It should be understood that alternative image sensors having similar characteristics and performance of sensing images in low-light and NIR conditions may be used in accordance with an embodiment.

One skilled in the art shall recognize that the image sensor/lens 152 could be a color, high resolution (e.g., 3-10+ megapixel) image sensor/lens combination—consistent with more traditional trail cameras—to provide full-color, high resolution images of animals or other targets. As cellular and other wireless networks enhance their speed and transmission capabilities (as well as network rates become more affordable), the transmission of such imagery could become more practical and expected. Alternatively, for a non-communication-enabled camera unit 100, low-resolution or high-resolution images may be stored on removable memory card 146, as an alternative to wireless transmission, or a scheme may be used that uses a combination of storage of image data and after-the-fact (i.e., time-shifted) wireless transmission, consistent with more traditional approaches.

An image sensor cover 104, fabricated of optical-grade plastic or glass, may be positioned within an aperture of the front housing 102a and positioned forward of the image sensor/lens 152. The image sensor cover 104 may provide a weatherproofing or waterproofing seal. In one embodiment, the image sensor cover 104 does not have an optical filter; however, an optical filter(s) to transmit light of predetermined wavelengths may be provided, whether incorporated into the image sensor cover 104 or added to the optical path through the use of dye and/or coatings. In one embodiment, as further illustrated in FIGS. 2A and 2B, the combination of the image sensor/lens 152, the image sensor cover 104 and their proximate position is intended to provide camera unit 100 a wider-than-normal horizontal IFOV.

In one embodiment, surrounding the image sensor/lens 152, an IR LED PCB 164 is provided that includes at least one LED. The illustrated IR LED PCB 164 includes thirty infrared LEDs (e.g., arranged in six string of five LEDs) configured in a circular arrangement to evenly distribute light about the image sensor/lens 152. It is recognized that this IR LED PCB 164 could take any number of physical arrangements, number of LEDs (e.g., 1 to 50+), and placement, e.g., located to one side of the image sensor/lens 152, partially about the image sensor/lens 152, or encompassing the image sensor/lens 152 (as shown). In accordance with an aspect, selection and arrangement of the LEDs complement the image sensor/lens 152, particularly in low-light environments. In one embodiment, the LEDs have a wavelength of 850 nm with a half-brightness angle of approximately 60° and radiant intensity of 55 mW/sr.

The LEDs are positioned so that IR light generated by the LEDs are transmitted through the illumination source lens 108, or more specifically, an IR LED ring lens 108. The IR LED ring lens 108 is fabricated of optical-grade plastic or glass. Operationally, the IR LED ring lens 108 guides and focuses the illumination of the LED PCB 164 to define an area to be illuminated, where the area of illumination should at least cover a portion of the prescribed horizontal MFOV of the PIR sensor 156. While the image lens cover 104 and the illumination source lens 108 may be separate components, the cover 104 and lens 108 may also be integrated into a single component as shown in FIG. 1D.

In an embodiment, the horizontal MFOV operatively aligns with the horizontal IFOV of image sensor/lens 152 (FIG. 2A)). This alignment differs from conventional trail camera that purposefully narrows the horizontal IFOV relative to the horizontal MFOV (or vice versa). In operation, the presence (or motion) of an animal or other target forward of the camera unit 100 and in such horizontal MFOV is detected by the PIR sensor 156, the camera unit 100 is activated, and the animal (or other target, as the case may be) is imaged via the image sensor/lens 152, as described further below, provided that such target remains in the horizontal MFOV/IFOV.

FIG. 2A illustrates a plan view, showing a horizontal IFOV of the image sensor/lens 152 of the camera unit 100. The horizontal IFOV (θ) may be within the range of approximately 40° approximately 70°, or be within the range of approximately 45° to approximately 65°, or be within the range of 50°-60°, or be equal to approximately 54°. FIG. 2B illustrates a side view of a vertical IFOV of the image sensor/lens 152 of the camera unit 100. The vertical IFOV (φ) may be within the range of approximately 30° approximately 60°, or be within the range of approximately 35° to approximately 65°, or be within the range of approximately 40° approximately 60°, or be approximately equal to 42°. Being approximately a certain number of degrees (e.g., 60°) means being within a few degrees thereof (e.g., 57° to 63°).

Operatively, FIGS. 2A and 2B illustrate a camera unit 100 positioned relative to a target (T) so that the target (T) is positioned forward of the camera unit 100. The camera unit 100 may be mounted to a fixed position (e.g., a wall, a tree, a T-post). The target (T) is located, for the purposes of this example, a distance (D) from the housing face of the camera unit 100 on a centerline (C), wherein the illustrated distance (D) is approximately 35 ft. For a distance (D) of approximately 35 ft., the illustrated IFOV, horizontal and vertical, encompass target (T). In FIG. 2A, it is illustrated that the horizontal IFOV extends a width (W) on either side of the target (T) (found on a centerline (C)). For the illustrated example of (D) being approximately 35 ft., (W) would equal at least 18 ft (or a total FOV width of more than 35 ft at (T)). Practically, when viewing a target (T), which may be part of greater activity (or in the case of feral pigs, movement and activity of a sounder), there is value in observing an area surrounding the target (T) to visually verify a certain or desired number or all members of the group are at or about the target (T).

Operatively, a user may properly mount and orient the camera unit 100 so as to establish a desired MFOV/IFOV to encompass the target (T), which may include a path, an animal feeder, water source, a trap or trapping system, or other desired target to be monitored. In one embodiment, in low-light/no-light conditions, an operative linkage between the IR LED PCB 164, the ambient light sensor 106 and the PIR sensor 156 may be configurable to enable the IR LED PCB 164 to illuminate—when needed due to ambient light conditions—upon detecting motion at or about the target (T) by the PIR sensor 156.

While vertical observation may or may not be needed (as some targets (T), for example, feral hogs, are exclusively located on the ground (G)); provided however, if trapping game birds, bear or other like animals, vertical observation may be of value), the vertical IFOV of the camera unit 100 also provides a greater-than-typical vertical IFOV relative to traditional trail cameras. Specifically, for the illustrated example of (D) being approximately 35 ft., a viewable height (H) of approximately 17 ft. at (T) is achievable with the camera unit 100 being located approximately 4 ft. above the ground (G).

It should be recognized that the combination of the image sensor/lens 152, the image sensor cover 104 and their proximate position can provide camera unit 100 a more traditional, narrow horizontal IFOV. Traditional trail cameras are developed to focus on a target (T) (e.g., an animal feeder) at a prescribed distance (D), which limits the ability to view proximate areas. While not as practical, the camera unit 100 may be so configured to provide users a more commonplace IFOV.

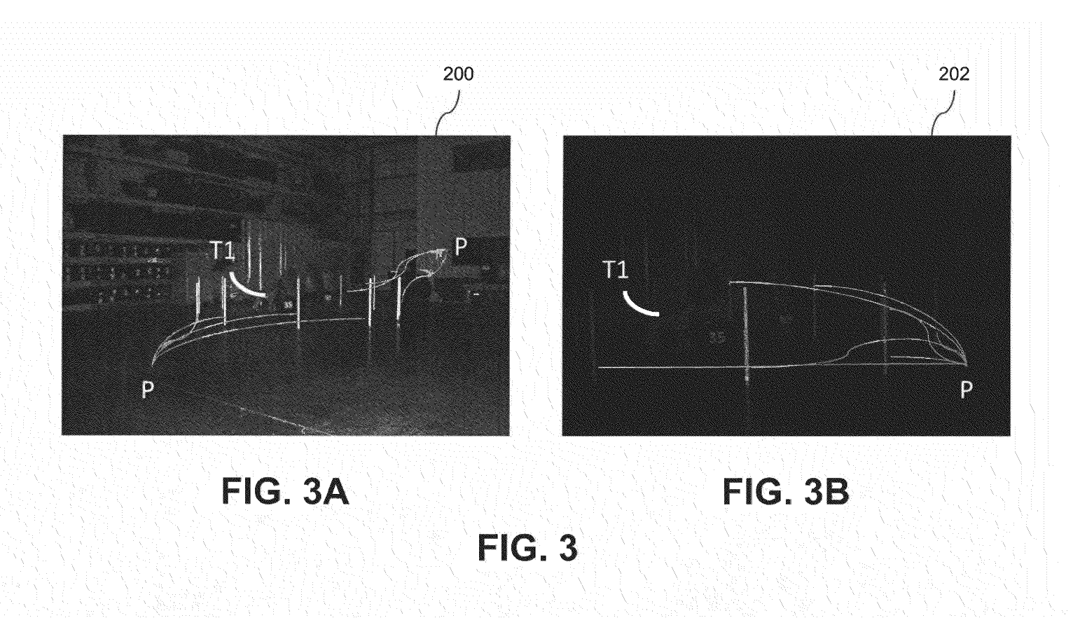

With regard to FIG. 3, comparative images includes: (a) a first image 200 of a target (T1) (surrounded by a marked circular perimeter (P) approximately 8 ft. from the target (T1)) captured by camera unit 100 (FIG. 1) and (b) a second image 202 of the target (T1) captured by a conventional trail camera. Environmental conditions, including light levels, for images 200 and 202 were identical. Images 200 and 202 were taken in a no-light environment (except for IR light provided by the illumination sources of the respective camera units, 100 and conventional) with the target (T1) located at 35 ft. from the respective camera units, 100 and conventional. Based on the characteristics and functional alignment of image sensor/lens 152, image sensor cover 104, and IR LED PCB 164, image 200 reflects a wider-than-normal horizontal IFOV, higher contrast, sharper, and clearer resulting image. Image 202 illustrates the challenges of conventional image sensors, including narrow horizontal IFOVs, and the consequence of light sensitivity not including NIR/IR wavelengths. In contrast, a user of camera unit 100 would be able to clearly view not only the target (T1) but near-by animals or other targets approaching or moving away from target (T1) and the marked perimeter (P).

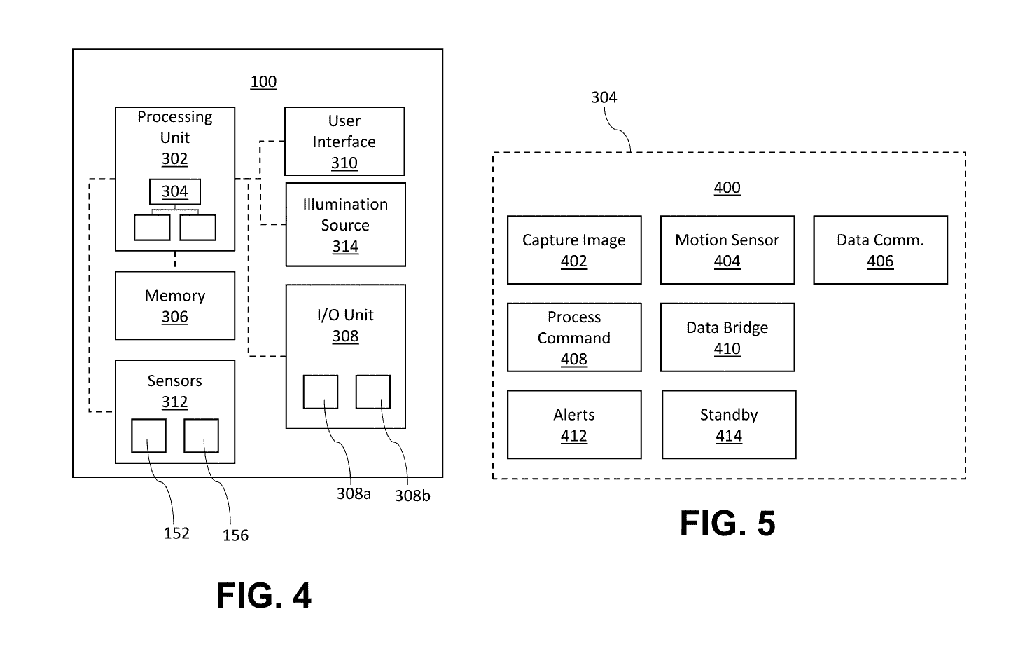

With regard to FIG. 4, an illustration of electrical components of the camera unit 100 is shown. The camera unit 100 may include a processing unit 302 that executes software 304. The software 304 may be configured to perform the functionality of the camera unit 100 for (i) monitoring motion within a MFOV; (ii) activating the system upon detecting such motion; and (iii) capturing images. For communication-enabled embodiments, the software 304 further may perform other functions, including (iv) notifying a user of motion and (v) transmitting images and streaming, live video to such user. The processing unit 302 may be formed of one or more computer processors, image processors, or otherwise, and be in communication with and control a memory 306, whether integrated or removable, as well as an input/output (I/O) unit 308.

The I/O unit 308 may include a variety of features depending on the embodiment of the camera unit 100. Specifically, the I/O unit 308 may include a wireless communications element 308a, which permits communication with an external wireless network (e.g., local communication network, cellular network). Specifically, element 308a enables instructions and/or commands to be received from remote users and transmit status information, instructions and/or data, including still and video imagery, to such users.

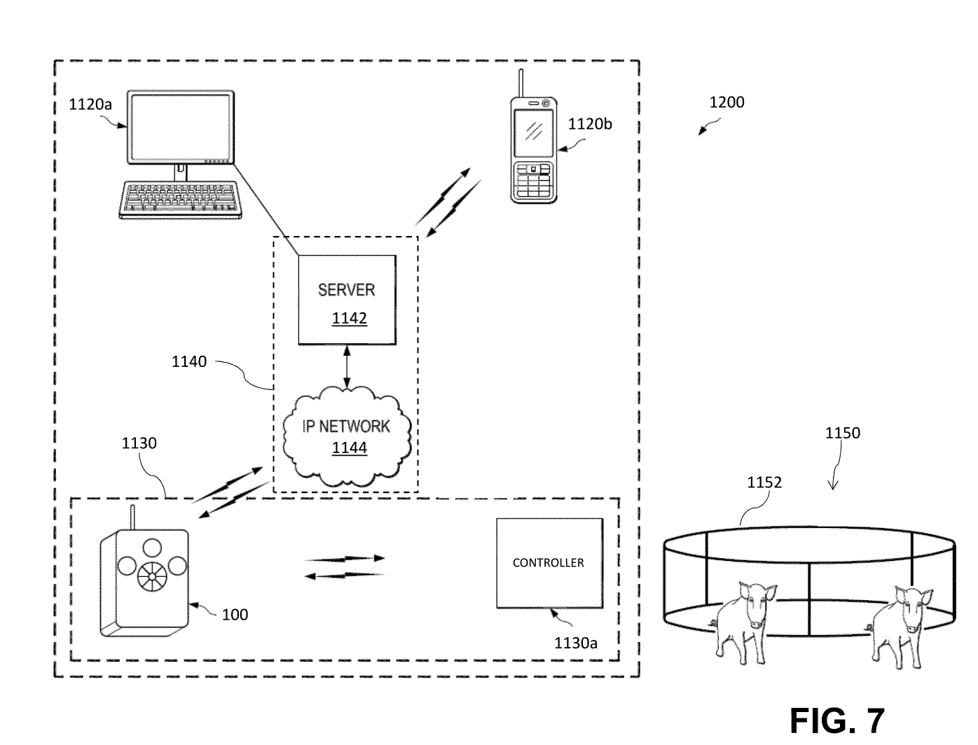

The I/O unit 308 may further include a wireless communications element 308b, which may permit communications with one or more external devices (FIGS. 7, 8, and 9) via a personal/local communication network, for example, using ZigBee® communications protocol or similar protocol. Specifically, element 308b may enable information (e.g., status information, sensed information or data) to be received from such external devices to be delivered to remote users and, in other embodiments, transmit status information, instructions and/or data from remote users to such external devices to, for example, control such external devices.

The processing unit 302 may further be in communication with a user interface 310, such as a keypad (not shown) and/or LCD 136, which may be a touch-screen. The processing unit 302 may further be in communication with and control sensors 312, including at least PIR sensor 156 and image sensor/lens 152. The processing unit 302 may further be in communication with and control an illumination source 314, which could take the form of the IR LED PCB 164 or could take the form of a flash or other controllable (switchable) visible light.

With regard to FIG. 5, a block diagram of illustrative software modules 400 of software 304, which may be configured to be executed by the processing unit 302 of the camera unit 100. The modules 400 may include a capture image module 402 that is configured to capture still images and/or video by the camera unit 100 using the image sensor/lens 152, as described above. In capturing such images, the module 402 may be configured to receive information/data from the image sensor/lens 152, process or manage such received information/data, and then store such image-related information/data into a memory (e.g., memory 306, memory card 140) and/or, for a communications-enabled embodiment, transmit such image-related information/data to an external communication network.

A motion sensor module 404 may be configured to sense motion of animals or other targets (e.g., people) via a PIR sensor 156. The motion sensor module 404 may be configured to generate a motion detect signal upon the PIR sensor 156 receiving reflected light from an animal or such other target within a MFOV of the PIR sensor 156. A motion detect signal may be used to notify or initiate other module(s), for example, a data communications module 406 (for communications-enabled embodiments) to communicate an alert to a user and/or to initiate recording and/or communication of image data/information.

The data communications module 406 may be configured to communicate information, data, instructions and/or commands to a user and/or an external device(s). This module effects the receipt of information (e.g., status information, sensed information or data) from external devices to be delivered to remote users and, in other embodiments, transmit status information, instructions and/or data from remote users to such external devices to, for example, control such external devices. Depending on the target of such communication (e.g., user, camera unit 100, external device) a communication network—wide-area or local-area—is selected and used. Information and/or data may include, among other types of data (outlined below), image data, whether stills or real-time streaming video, captured from the image sensor/lens 152. In the context of the external device(s) and their potential interaction with a camera unit 100, the data communications module 406 may serve as a central point for a command-and-control hub system as controlled per a remote user. In such an embodiment, module 406 communicates with a local communication network, e.g., a wireless network using an IEEE 802.15 standard, as but one example, a ZigBee® communications protocol. For any such embodiment, the camera unit 100 serves a “master” device that communicates with, and in certain scenarios, controls external device(s) as “slave” devices (e.g., controllers, feeders, illumination devices, irrigation and water systems, gates). It should be understood that other local, wireless standards and devices may be used.

The process commands module 408 may be configured to receive and process commands for the camera unit 100. For example, commands, such as “enter a low-power mode” (e.g., when there is no detected motion), “initiate image capture,” and “stop image capture.” The process commands module 408 may modify a sensitivity characteristic of the motion sensing functionality (i.e., PIR sensor 156), activate an illumination source 314 (upon detected motion) when ambient light is below a threshold level, and/or increase an intensity characteristic or focal point of the camera unit 100 illumination source 314. In a complementary embodiment, this module may be subject to user-issued commands communicated through a wide-area communication network. Specifically, the process commands module 408, in combination with other modules, may effect the command, control, and management of external devices (e.g., controllers, feeders, illumination devices, irrigation and water systems, gates). Also, internal processes of the camera unit 100 may be modified by user-issued commands. As but one example, if the camera unit 100 was equipped with a zoom lens (not shown), the process commands module 408 may control, internally (based on detected motion within the MFOV) or externally (based on user-issued commands), the magnification of such zoom lens.

A data bridge module 410 may be configured to cause the camera unit 100 to operate as a “bridge” by transmitting status information, instructions, and/or data to and/or receiving status information, instructions, and/or data from nearby external device(s) and communicating such information/data via a wide-area communication network. Other examples of the bridge functionality may include receiving information/data from a tag, band, implant or other device on or in wild, feral or domesticated animals (e.g., ear tags, bands, collars, implants or consumables), equipment (e.g., tractors, sprinklers, irrigation systems, gates), and/or sensors (e.g., temperature, wind velocity, soil moisture, water level, air quality, including pollen or pollutant content and/or levels, ambient light levels, humidity, soil composition, animal weight, animal health and/or condition) via a personal/local communication network.

For certain embodiments, an alerts module 412 may be configured to generate alerts or messages that may be communicated by the data communications module 406 to a user. The alerts module 412 may be configured with threshold parameters that, in response to exceeding such threshold parameters, the module issues a signal that results in a user-directed alert and/or message to be generated and delivered.

A standby module 414 may be configured to cause the camera unit 100 to operate in a “rest” state between periods of activity (e.g., capturing images, transmitting information and data), where many of the electronic components, excluding the PIR sensor 156, are turned off or maintained at low- to very low-power during such rest states. Upon detection of motion within the MFOV, as described above, the standby module 414 is deactivated, and the camera system 100 and the remaining modules, individually or in some combination, are initiated or become active.

Additional and/or different modules may be used to perform a variety of additional, specific functions. As but one example, a small/large feed dispense module (not shown) may be provided (rather than inclusion within the process commands module 408) to cause a feeder 1160 (FIG. 8) proximate to a camera unit 100 to release a small amount of feed to attract animals and then a larger amount of feed (or other attractant) at or before arrival of a desired animal type (e.g., feral pigs), whether based on user control, a predetermined setting and/or detected motion and activity. Functionality for the amount of feed to be dropped may be incorporated into the feeder itself, within the camera unit 100, at a remote server, or controlled by the user. As another example, the feeder 1160, the camera unit 100, or other external device may include an animal call device that may be configured to generate audio sounds of one or more animals (e.g., wild turkey, geese) of which the user wants to capture, which could be subject to control in a similar manner whether through the process commands module 408 or another module.

As discussed above, in one embodiment, camera unit 100 may serve as a traditional, standalone trail camera, which is placed at a site, activated, and directed toward a target area. The camera unit 100 may operate, for example, in a standby state to detect motion within or about such target area, whether in day or night settings; initiate operation of the camera unit 100 upon detection of motion; and capture images (whether still or video) for storage on a memory card 146. In this operational scenario, a user would visit the camera unit 100 to retrieve the memory card 146 to view earlier captured images.

In another embodiment, as schematically illustrated in FIG. 6, a monitoring system 1100 may provide a remote user a means to monitor a target area from a distant location using still images and/or real-time video. A communications-enabled camera unit 100 may be an element of this monitoring system 1100.

In this illustrated example, the monitoring system 1100 includes three primary components: a user device(s) 1120, an on-site system 1130, and an interposed communication network 1140 (e.g., a wide-area communication network). Camera unit 100 is placed at a site, activated, and directed toward the target area. The camera unit 100 would operate, for example, in a standby state (ready to detect motion within or about such target area, whether in day or night settings); initiate operation of the camera unit 100 upon detection of such motion; and capture images (whether still or video) for transmission to a remote user via the communication network 1140. The communications network 1140 may include a conventional server 1142 to store and/or manage data transferred through the control and operation of the camera unit 100 and IP network 1144 (or like components as are well known in the art). The user device 1120 receives information from the on-site system 1130, but also may transmit control commands (e.g., terminate transmission of images, initiate transmission of images, activate illumination source) through the communication network 1140.

The user device(s) 1120 may be a computer 1120a, a cellular device 1120b (e.g. smart phone), pager (not shown) or other similar electronic communications device. At the user device 1120, data is managed and presented through an appropriate user interface, for example, a desktop application (for computer 1120a) or smartphone application (for cellular device 1120b). The on-site system 1130, for this illustrated system, may include the camera unit 100.

An extension of the prior embodiment and schematically illustrated in FIG. 7, a user-controlled animal trapping system 1200 may provide a remote user a means to (a) monitor a trap area from a distant location using still images and/or real-time video and (b) actuate an enclosure (or enclosure component, as the case may be) to effect the trapping of wild animals or other targets. A communications-enabled camera unit 100 may be an element of this trapping system 1200.

The user-controlled animal trapping system 1200 includes three primary components: a user device(s) 1120, an on-site system 1130, and an interposed communication network 1140 (e.g., a wide-area communication network). Camera unit 100 is placed at a site, activated, and directed toward the target area. The camera unit 100 would operate, for example, in a standby state (ready to detect motion within or about such target area, whether in day or night settings); initiate operation of the camera unit 100 upon detection of such motion; and capture images (whether still or video) for transmission to a remote user via the communication network 1140 (consistent with that described above). The user device 1120 receives information from the on-site system 1130, but also may transmit control commands (e.g., terminate transmission of images, initiate transmission of images, activate illumination source, and/or actuate the enclosure or enclosure component through the communication network 1140.

Similar to above, the user device(s) 1120 may be a computer 1120a, a cellular device 1120b (e.g. smart phone), pager (not shown) or other similar electronic communications device. At the user device 1120, data is managed and presented through an appropriate user interface, for example, a desktop application (for computer 1120a) or smartphone application (for cellular device 1120b). The on-site system 1130, for this illustrated system, may include the camera unit 100 and controller 1132. The camera unit 100 may communicate with the controller 1132, whether wirelessly (preferably, through a local communication network), wired, or as an integrated unit. The user-controlled animal trapping system 1200 includes a controllable, enclosure mechanism 1150, which may include a suspendable enclosure (movable from a raised position to a lowered position) 1152, a drop net (not shown), a corral structure with a closable gate or door (not shown), a box structure with a closable gate or door (not shown), or similar structure.

Expanding on the abbreviated description above for this embodiment, the camera unit 100, positioned at a trap area, operates to detect motion within a MFOV. Upon detecting such motion, the camera unit 100 exits its standby state, which may include activating its illumination source, if warranted (i.e., low- or no-light conditions); taking a still image of the IFOV; and transmitting such still image (in the form of an alert) to a user via the communications network 1140, which is delivered to the user through a user device 1120(s). Because animal motion, whether alone or in groups, make effect multiple such alerts, a user may set a rule at the camera unit 100, the server 1142, and/or software application of the user device 1120 to not notify the user unless a certain amount of motion is sensed and/or after a lapse of time, measured from the last motion detection.

Upon receiving an alert or upon the user's own initiative, the user may send a command to the camera unit 100 to initiate real-time streaming video, which is delivered to the remote user via the communications network 1140. Upon receiving such user-command, the camera unit 100 activates its illumination source, if warranted (i.e., low- or no-light conditions), activates the image sensor/lens 152, and begins transmission of real-time live video, which the user receives and can view via the user device 1120.

Using real-time streaming video, the user can watch both a trap area and an area surrounding such trap area to gain an understanding of animal movement in and out of the trap area. When an optimum number of animals are within the trap area, the user sends a command (using a user device(s) 1120) to the camera unit 100 to deploy the enclosure mechanism 1150. Upon receiving such user command, the camera unit 100 transmits a related instruction to the controller 1132 to effect such deployment. Through such deployment and thereafter, the user may watch real-time streaming video of the trap area, which includes, for example, the enclosure 1152 and any and all captured animals.

Referring to FIG. 8, an operational embodiment of the on-site system 1130 and the enclosure 1152 of the user-controlled animal trapping system 1200 are illustrated. The on-site system 1130 includes the camera unit 100 mounted to a tree. While the illustrated system may include any number of controllable, enclosure mechanisms 1150, the enclosure 1152 may be a robust, rigid enclosure capable of being raised to a suspended position over a trap area and supported by one or more support members. The enclosure 1152 is movable from such suspended position to a lowered position resting on the ground; in the lowered position, the enclosure 1152 defines a confined perimeter that partitions the trap area from its surroundings. In the illustrated suspended position, the enclosure 1152 is operatively suspended above the line-of-sight of an animal to be trapped, for example, feral hogs (as shown). Suspending the enclosure 1152 above an animals' line-of-sight avoids triggering their suspicion and their inherent avoidance tendencies.

The user places bait (e.g., corn for feral hogs) within the trap area (beneath and within the to-be-perimeter of the enclosure 1152) to prepare the trap area. To ready the enclosure 1152, the user raises the movable enclosure 1152 to a suspended position and releasably couples the enclosure 1152 to a release mechanism/controller 1132. The release mechanism/controller 1132 communicates with the camera unit 100. The release mechanism/controller 1132 further releasably holds the enclosure 1152 in the suspended position until the user issues an actuation signal to drop the enclosure 1152 to the lowered position.

In operation, as more fully described above, the user assesses the number of animals in and about the trap area through viewing the trap and surrounding areas through a user device 1120 in real-time. When all animals are determined to be within the trap area, the user transmits a drop signal via the user device 1120 (FIG. 7). The camera unit 100 communicates and actuates the release mechanism/controller 1132 in response to receiving the user-issued drop signal, causing the release mechanism/controller 1132 to release the enclosure 1152. The released enclosure 1152 quickly drops to the ground, trapping the animals within the trap area. Through such deployment and thereafter, the user may watch real-time streaming video of the trap area (which includes, for example, the enclosure 1152 and any and all captured animals).

It should be understood that many of the features and functions of the camera unit, server, user device, controller and/or other devices located at the trap structure may be executed by more than one of the components of the illustrated systems. For example, functionality to initiate the enclosure 1152 to drop may be incorporated into the camera unit 100, controller/release mechanism 1132, server 1142 and/or user device 1120. That is, logic for performing various functions may be executed on a variety of different computing systems, and various embodiments contemplate such configurations and variations.

A variation of the above embodiment further is illustrated in FIG. 8, wherein a feeder 1160 is provided within (but may be outside or on) the perimeter of the enclosure 1152 to deliver bait 1162 within the perimeter of the enclosure 1152. The feeder 1160 may be manually operated or on a timer (independent of the on-site system 1130); however, the feeder 1160 may also be in communication with the camera unit 100, which would allow a user to also selectively disburse bait 1162, of whatever form, to the trap area using a user device 1120. The feeder 1160 may be of a configuration and design well known in the art and simply equipped with communication equipment to enable an operative connection to the camera unit 100. The feeder 1160 could include, or be solely comprised of, an animal call mechanism to issue natural animal sounds on command and/or to disburse scents (or other attractants) to facilitate movement of animals into the enclosure 1152.

In another embodiment, as illustrated in FIG. 9, a sensor and data/information network 1300 may provide a remote user a means to monitor an area (IFOV); transmit/receive data/information from sensors and other sources; and transmit/receive command and control instructions to actuators, switches, and controllable mechanisms. As described above, the network 1300 may include receiving information/data from a tag, band, implant or other device on or in wild, feral or domesticated animals (e.g., ear tags, bands, collars, implants or consumables), equipment (e.g., tractors, sprinklers, irrigation systems, gates) and/or sensors (e.g., temperature, wind velocity, soil moisture, water level, air quality, including pollen or pollutant content and/or levels, ambient light levels, humidity, soil composition, animal weight, animal health and/or condition) via the illustrated personal/local communication network. Camera units 100 further may be wirelessly linked so as to transmit and relay information between camera units (100a, 100b), extending the functional range of any given camera unit 100 within the network 1300.

As illustrated in FIG. 9, camera unit 100a is mounted to a T-post 1360a, and camera unit 100b is mounted to a T-post 1360b. As shown, camera unit 100b is a “slave” to a “master” camera unit 100a, the latter communicating to the network 1140. Notwithstanding, it is recognized that neither camera 100a, 100b must be subservient, wherein each camera 100a, 100b may communicate with the network 1140 as well as transfer information, data, instructions, or commands therebetween.

FIG. 9 further illustrates camera unit 100a collecting (and/or writing) data to animal bands/tags 1320a, 1320b. Importantly, the transmission/receipt of information relates to proximity to the camera unit 100a and does not relate to a presence within the IFOV/MFOV. The camera unit 100a further may function to transmit images, whether still or video, as described in significant detail above. The camera unit 100a further may transmit command and control instructions and/or receive status information from control unit 1350, which controls the flow of water through faucet 1352 into a related water trough 1354. The camera unit 100a also may transmit command and control instructions and/or receive measured information/data from deployed environmental sensors, including, for example, water quality sensor 1340 and soil moisture sensor 1330. Camera unit 100b may transmit command and control instructions and/or received measured information/data from deployed environmental sensors, including, for example, a weather station capable of measuring temperature, wind speed, air quality, UV exposure and/or other atmospheric and environmental conditions. It is notable that camera unit 100b may or may not include an integrated image sensor, but rather it may serve to only collect and transmit information/data to a user, whether through camera unit 100a or otherwise. At the user device 1120, data/information is managed and presented through an appropriate user interface, for example, a desktop application (for computer 1120a) or smartphone application (for cellular device 1120b).

Although particular embodiments of the present invention have been explained in detail, it should be understood that various changes, substitutions, and alterations can be made to such embodiments without departing from the scope of the present invention as defined by the following claims.

What is claimed:

1. A trail camera to transmit image data to a communications network to enable a remote user to monitor a scene in low-light conditions in real-time, comprising:
a lens configured to capture the scene;
an infrared (IR) illumination device configured to illuminate the scene at an IR wavelength in the low-light conditions;
an image sensor having a wavelength sensitivity over IR wavelengths, and being configured to sense the scene captured by said lens and to produce image signals representing the scene;
a processing unit, in communication with said image sensor, being configured to receive and process the image signals;
an antenna configured to communicate with the communications network;
an input/output (I/O) unit, in communication with said processing unit and said antenna, being configured to communicate the image signals from said processing unit to the communications network in response to production of the image signals; and
a housing adapted to house said lens, IR illumination device, image sensor, processing unit, and I/O unit.

2. The trail camera according to claim 1, wherein the image signals are monochromatic image signals.

3. The trail camera according to claim 1, wherein said lens defines a horizontal field-of-view within a range of approximately 45° and approximately 65°.

4. The trail camera according to claim 3, wherein said lens defines a horizontal field-of-view within a range of approximately 50° and approximately 60°.

5. The trail camera according to claim 4, wherein said lens defines a horizontal field-of-view of approximately 54°.

6. The trail camera according to claim 1, wherein said IR illumination device includes at least one infrared light emitting diode (LED).

7. The trail camera according to claim 6, wherein said at least one LED produces a wavelength aligned with a wavelength sensitivity of said image sensor.

8. The trail camera according to claim 7, wherein said at least one LED produces a wavelength of approximately 850 nm.

9. The trail camera according to claim 1, further comprising a motion detection sensor, in communication with said image sensor, configured to sense motion within the scene, wherein said image sensor is further configured to sense the scene in response to (a) motion sensed within the scene or (b) a user-issued command received from via the communications network via said I/O unit.

10. The trail camera according to claim 1, wherein the communications network is a wide-area communications network, and said I/O unit includes a plurality of I/O devices configured to communicate using distinct communications protocols, wherein a first communications protocol corresponds to the communication network, and a second communications protocol corresponds to a local area communications network that operatively links the I/O unit to at least one external device.

11. The trail camera according to claim 10, wherein the user may deliver commands to the at least one external device to enable the user to control the at least one external device, said I/O unit being configured to receive the commands and transmit the commands to the at least one external device.

12. The trail camera according to claim 1, wherein said housing further includes a T-post mounting structure to engage a T-post and support the trail camera.

13. The trail camera according to claim 1, further comprising an ambient light sensor, in communication with said IR illumination source, being configured to produce an activation signal in response to low-light conditions, wherein said IR illumination source selectively illuminates the scene in response to the activation signal.

14. A trail camera configured to communicate to a communication network to enable a user to monitor a horizontal, first field-of-view encompassing a target area and receive data from an external device located proximate to the target area, comprising:
a housing;
a lens configured to capture an image of the target area in the first field-of-view;
an infrared (IR) illumination device configured to selectively illuminate the target area in the first field-of-view at an IR wavelength;
an image sensor, having a wavelength sensitivity at least at the IR wavelength, being configured to sense the target area in the first field-of-view and to produce image signals representing the sensed target area in the first field-of-view;
a processor in communication with said image sensor, and configured to receive and process the image signals;
an antenna configured to communicate with the communications network;
an input/output (I/O) unit, in communication with said processor and said antenna, being configured to communicate image signals from said processor to the communications network in response to production of the image signals; and
a transceiver, in communication with the external device via said I/O unit, configured to receive data from the external device,
wherein said housing is adapted to house said lens, IR illumination device, image sensor, processor, and I/O unit.

15. The trail camera according to claim 14, wherein the image signals are monochromatic image signals.

16. The trail camera according to claim 14, wherein the first field-of-view is within a range of approximately 45° and approximately 65° originating at said lens.

17. The trail camera according to claim 16, wherein the first field-of-view is within a range of approximately 50° and approximately 60° originating at said lens.

18. The trail camera according to claim 17, wherein the first field-of-view is approximately 54°.

19. The trail camera according to claim 14, wherein said IR illumination device includes at least one infrared light emitting diode (LED).

20. The trail camera according to claim 19, wherein said at least one LED has a wavelength substantially aligned with a wavelength sensitivity of the image sensor.

21. The trail camera according to claim 14, further comprising a motion detection sensor, in communication with said image sensor, configured to sense motion within a horizontal, second field-of-view encompassing a second target area, wherein said image sensor is further configured to sense the target area in said first field-of-view in response to (a) motion sensed within said second field-of-view or (b) a user-issued command received from via the communications network via said I/O unit.

22. The trail camera according to claim 21, wherein the first field-of-view and the second field-of-view are substantially aligned.

23. The trail camera according to claim 14, wherein the external device is a sensor that measures a condition and is configured to generate data corresponding to said condition, and generated data is communicated to the user via said input/output (I/O) unit and said communication network.

24. The trail camera according to claim 14, wherein the external device is a mechanism having a conditional status and is configured to generate data corresponding to the conditional status, and generated data is communicated to the user via said input/output (UO) unit and said communication network.

25. The trail camera according to claim 14, wherein said transceiver is capable of communicating user-issued command to the external device.

26. The trail camera according to claim 25, wherein the external device, having an operational state, is configured to modify the operational state in response to receiving user-issued commands received from said transceiver.

27. The trail camera according to claim 14, wherein said housing further includes a T-post mounting structure to engage a T-post and support the trail camera.

28. An animal trapping system viewable and controllable by a remote user using an electronic device, comprising:
a trap enclosure configured to deploy to confine animals within a trap area defined by said trap enclosure;
a controller configured to deploy said trap enclosure in response to a user-issued command; and
a head unit, including a camera unit and a plurality of communications modules, and being configured to:
produce video signals representative of at least the trap area;
communicate with the electronic device via a wide-area communications network;
communicate with said controller via a local wireless network;
transmit the video signals to the electronic device for user-viewing proximate to production of the video signals, receive the user-issued command from the electronic device; and
transmit a received user-issued command to said controller to deploy said trap enclosure to confine animals within the trap area as viewed via the electronic device.

29. The animal trapping system according to claim 28, wherein said head unit further includes a motion detector to detect animal motion within at least the trap area and to produce a signal representative of detected animal motion, and said head unit further being configured to produce and transmit a user-alert to the electronic device in response to said signal.

30. The animal trapping system according to claim 28, wherein a field-of-view of the motion detector is substantially aligned with a field-of-view of the camera unit.

31. The animal trapping system according to claim 28, further comprising a feeder to selectively deliver edible bait within said trap enclosure, wherein said feeder is configured to communicate with said head unit via the local wireless network and is responsive to user-issued commands issued from the electronic device.

32. The animal trapping system according to claim 28, further comprising an attractant mechanism to selectively deliver an animal attractant proximate to said trap enclosure, wherein said attractant mechanism is configured to communicate with said head unit via the local wireless network and is responsive to user-issued commands issued from the electronic device.

33. The animal trapping system according to claim 28, wherein said trap enclosure includes a suspendable enclosure that may be elevated above the trap area to enable animal ingress and egress from the trap area, and wherein said suspendable enclosure is movable from a suspended position to a lowered position when deployed in response to said user-issued command.

34. The animal trapping system according to claim 28, wherein the camera unit further is configured to operate in low-light conditions.

35. The animal trapping system according to claim 34, wherein the video signals are monochromatic video signals.

36. The animal trapping system according to claim 28, wherein said wide-area communications network is a cellular/data network.

37. The animal trapping system according to claim 28, wherein said head unit further includes a motion detector to detect animal motion within a field-of-view including the trap area and a proximate area surrounding the trap area.

38. The animal trapping system according to claim 28, wherein said head unit produces video signals representative of a field-of-view including the trap area and a proximate area surrounding the trap area.
